(19) United States
(12) Patent Application Publication
(10) Pub. No.: US 2026/0192228 A1
(43) Pub. Date: Jul. 9, 2026

(54) ROUND FILTER ELEMENT AND FILTER SYSTEM

(71) Applicant: MANN+HUMMEL GmbH, Ludwigsburg (DE)

(72) Inventors: Pascal NEEF, Trossingen (DE); Philipp HETTKAMP, Steinheim (DE); Johannes GRAD, Simbach (DE); Pedro Miguel PEREIRA MADEIRA, Bietigheim-Bissingen (DE); Eva HALLBAUER, Himmelkron (DE); Peter PEKNY, Neuenmarkt (DE); Andreas WEBER, Freiberg (DE); Christoph WITTMERS, Bietigheim-Bissingen (DE); Steffen GERLACH, Nufringen (DE); Mario RIEGER, Ludwigsburg (DE); Markus HANSELMANN, Lauffen (DE); Friedrich KUPFER, Marklkofen (DE); Dieter WEISS, Gefrees (DE); Daniel SCHMID, Sachsenheim (DE); Dennis STARK, Mauer (DE)

(21) Appl. No.: 19/553,860

(22) Filed: Mar. 2, 2026

Related U.S. Application Data
(63) Continuation of application No. PCT/EP2024/072801, filed on Aug. 13, 2024.

(30) Foreign Application Priority Data
Sep. 7, 2023 (DE) 10 2023 124 081.1

(51) Int. Cl. B01D 46/00; B01D 46/24; B01D 53/04; H01M 8/0662

(52) U.S. Cl. CPC B01D 46/0036; B01D 46/2414; B01D 53/0415; H01M 8/0687; B01D 2253/102

(57) ABSTRACT

A round filter element for filtering a fluid includes a filter medium body with a particle filter medium. The filter medium body surrounds a longitudinal axis and encloses an interior. An end body delimits the filter medium body at an end face of the filter medium body. The end body is an open end plate with a through opening in fluid communication with the interior. A sorption element is arranged in the through opening and connected directly or indirectly to the filter medium body or the end plate. The sorption element is flowed through by the fluid serially relative to the filter medium body in the direction of the longitudinal axis. The sorption element is sealed relative to the through opening. A filter system is provided with the filter element arranged in a filter housing between a fluid inlet and a fluid outlet.

### CROSS-REFERENCE TO RELATED APPLICATIONS

This application is a continuation application of international application No. PCT/EP2024/072801 having an international filing date of Aug. 13, 2024, and designating the United States, the international application claiming a priority date of Sep. 7, 2023, based on prior filed German patent application No. 10 2023 124 081.1, the entire contents of the aforesaid applications being incorporated herein by reference to the fullest extent permissible.

### BACKGROUND

The invention concerns a round filter element for filtering a fluid, for example for filtering air, for a filter system, for example for an air filter system of a fuel cell system, as well as a filter system with a round filter element.

Fuel cell systems require often a particle filter and a sorption filter in order to filter particles as well as harmful gases from the intake air. The filter medium bodies of the different filtration stages have usually different dimensions.

US 2018/149119 A1 shows a filter arrangement with a round filter element with a filter medium body in whose open end plate, providing an outlet for the filtered fluid, an adsorber element is arranged. The adsorber element is flowed across in this context by the fluid filtered by the filter medium body so that harmful gases which are still contained in the filtered fluid may be adsorbed.

DE 10 2016 004 316 A1 discloses a flat secondary element which is inserted into the open end plate of a round main filter element at a clean side thereof and is axially flowed through in operation. The secondary element is separate from the main filter element and includes only a particle filter medium. The secondary filter element serves substantially the purpose of preventing a contamination of a clean side of the filter element arrangement with raw fluid to be filtered when exchanging the main filter element.

### SUMMARY

It is an object of the invention to provide a service-friendly and cost-efficient round filter element for filtering a fluid, for example for filtering air, for a filter system, for example for an air filter system of a fuel cell system, with a sorption element.

A further object is providing a filter system with such a service-friendly and cost-efficient round filter element.

The aforementioned object is solved according to an aspect of the invention by a round filter element for filtering a fluid, for example for filtering air, for a filter system, for example for an air filter system of a fuel cell system, at least including a filter medium body with a particle filter medium surrounding a longitudinal axis and enclosing an interior, two end bodies which delimit the filter medium body at end faces facing away from each other, wherein at least one end body is an open end plate and includes a through opening which is in fluid communication with the interior, a sorption element which is arranged in the through opening of the open end plate and fixedly connected indirectly or directly to the filter medium body or the end plate, wherein the sorption element may be flowed through by the fluid serially in relation to the filter medium body in direction of the longitudinal axis in an operating state, wherein the sorption element is sealed in relation to the through opening.

The further object is solved by a filter system for filtering a fluid, for example for filtering air, for example of a fuel cell system, including a filter housing with a fluid inlet and a fluid outlet, and including at least one round filter element which is arranged between the fluid inlet and the fluid outlet.

Embodiments and advantages of the invention result from the following description and the accompanying drawings.

According to an aspect of the invention, a round filter element for filtering a fluid, for example for filtering air, for a filter system, for example for an air filter system of a fuel cell system, is proposed, at least including a filter medium body with a particle filter medium surrounding a longitudinal axis and enclosing an interior, two end bodies delimiting the filter medium body at end faces facing away from each other, wherein at least one end body is an open end plate and includes a through opening which is in fluid communication with the interior, and a sorption element which is arranged in the through opening of the open end plate and is fixedly connected indirectly or directly to the filter medium body or the end plate. In this context, the sorption element may be flowed through by the fluid serially in relation to the filter medium body in direction of the longitudinal axis in an operating state. The sorption element is sealed in relation to the through opening.

The proposed round filter element includes a filter medium body which is configured as a particle filter as well as a sorption element which may be configured as an adsorption element or absorption element. The round filter element and the sorption element may be provided with a common open end plate which includes a through opening for the filtered fluid. In this way, the sorption element may be fixedly connected to the filter medium body and/or the open end plate.

By using a common end plate, the sealing action of both elements, filter medium body and sorption element, may be realized in one process step which is advantageous in regard to the production cost.

The particle filter may be designed, for example, as a folded cellulose bellows or synthetic bellows.

For adsorption of harmful gases, the sorption element may include, for example, active carbon, wherein the latter, enclosed between synthetic media layers, may be processed to an active carbon medium. This active carbon medium may be processed to a pleated bellows or alternatively to a cylinder-shaped wound bellows.

Furthermore, solutions are conceivable in which the active carbon is introduced in a flow-permeable closed hollow body. Coated honeycomb bodies are a further alternative for harmful gas adsorption.

The common open end plate between filter medium body and sorption element may be, for example of plastic material, polyurethane (PUR) foam or sheet metal.

The filter medium body as particle filter is radially flowed through in the round filter element while the gas adsorption in the sorption element is realized in axial flow direction. In this context, the sorption element may extend also into the clean air conduit of the filter housing and/or the fluid outlet of the filter housing, i.e., external to the end plate.

According to an embodiment of the round filter element, the sorption element may be embedded, at least partially, with an axially extending exterior side in the open end plate. For example, the round filter element may be connected by material fusion to the open end plate. In this manner, the sorption element may be joined seal-tightly to the end plate so that the filtered fluid of the filter medium body must flow completely through the sorption element and harmful gases may be adsorbed or absorbed in this way.

According to an embodiment of the round filter element, the sorption element may project at least partially into the interior of the filter medium body in direction of the longitudinal axis. In this way, a larger volume of the sorption element may be made available for the adsorption or absorption of the harmful gases.

According to an embodiment of the round filter element, the sorption element may project at least partially past the end face of the open end plate of the filter medium body in direction of the longitudinal axis. In this way, a larger volume of the sorption element may be made available for the adsorption or absorption of the harmful gases.

According to an embodiment of the round filter element, the sorption element may be delimited by oppositely positioned end faces in direction of the longitudinal axis, wherein an end face of the sorption element may be flush with the open end plate. In this way, the sorption element may be arranged so as to be flush in relation to the exterior of the round filter element or to the interior.

According to a configuration of the round filter element, the sorption element may have a cuboid contour which is aligned with outer edges substantially in direction of the longitudinal axis. In this context, a diagonal of an end face of the cuboid contour may correspond at most to a diameter of the through opening of the end plate. The cuboid contour provides, for example in case of a sorption element with a folded active carbon medium, an inexpensive embodiment of a sorption element.

According to a configuration of the round filter element, the sorption element may have a cylindrical contour which is aligned with a cylinder axis parallel, for example centered, in relation to the longitudinal axis. In this context, the sorption element may be arranged radially inside of the through opening. A cylinder-shaped contour may fill a round opening of the end plate, for example in case of a hollow cylindrical filter medium body, so that a cross section as large as possible for the flow of the fluid through the sorption element is made available.

According to an embodiment of the round filter element, the sorption element may include a folded sorption medium, wherein fold edges of the sorption medium may be arranged at a slant, for example perpendicularly, to the longitudinal axis. In this manner, a large surface area of the medium of the sorption element may be made available for the adsorption or absorption of the harmful gases.

According to an embodiment of the round filter element, the sorption element may include a sorption medium wound about the longitudinal axis. Such an arrangement of the sorption medium of the sorption element may also be manufactured cost-efficiently and, at the same time, make available a surface area as large as possible for the fluid to be filtered for adsorption or absorption.

According to an embodiment of the round filter element, the sorption element may include a lateral band at least at one axially extending exterior side. The axially extending exterior side may also be referred to as the axial exterior side in this context. For example, the round filter element may be seal-tightly closed by the lateral band.

The lateral band may be embedded in the open end plate in this context, for example may be connected by material fusion to the open end plate. On the one hand, the sorption element may be sealed at the exterior sides, particularly exterior sides of folds of a folded sorption medium. On the other hand, the lateral band may be used for joining to the end plate. For example, the lateral band may be embedded by molding in the end plate and fixedly connected to the end plate in this way.

According to an embodiment of the round filter element, the sorption element may include a sorption medium which is configured as loose material. The loose material may be arranged, for example, in a plastic housing with openings for flow of fluid therethrough and constitutes also a very cost-efficient embodiment of the sorption element. For this purpose, end faces of the housing may be covered in direction of the longitudinal axis, for example, by a permeable nonwoven which may be flowed through by the fluid.

According to an embodiment of the round filter element, a permeable nonwoven may be arranged at end faces of the sorption element. In this context, at least one end face, for example at least one end face disposed downstream, may include reinforcement ribs. The sorption medium may thus be arranged between the two end faces provided with the nonwoven. For reinforcement against the flow pressure of the flowing fluid, reinforcement ribs, for example crossing ribs, may be arranged at least at one end face, for example at least at a downstream end face.

According to an embodiment of the round filter element, the sorption element may include a honeycomb structure which includes channels open in direction of the longitudinal axis. In this context, the honeycomb structure may include the sorption medium. For example, in this context, the honeycomb structure may be coated with the sorption medium. Such a honeycomb structure may be conveniently produced, for example, as extruded plastic body. The application of active carbon may provide that a mechanically stable and lightweight sorption element for the adsorption or absorption of harmful gases may be made available.

According to a further aspect of the invention, a filter system is proposed for filtering a fluid, for example for filtering air, for example of a fuel cell system, including a filter housing, including a fluid inlet and a fluid outlet, and including at least one round filter element which is arranged between the fluid inlet and the fluid outlet.

With the proposed filter system, particles, for example dirt particles, may be filtered out of the fluid, for example air, and also harmful gases may be adsorbed or absorbed at a sorption element. Such an arrangement of a sorption element in a round filter element provides a particularly cost-efficient and effective solution because the entire fluid filtered by the particle filter must flow through the sorption element. In this manner, an efficient adsorption or absorption of harmful gases in the filter system may be ensured.

### BRIEF DESCRIPTION OF THE DRAWINGS

Further advantages result from the following drawing description. In the drawings, embodiments of the invention are illustrated. The drawings and the following description contain numerous features in combination. A person of skill in the art will consider the features expediently also individually and combine them to expedient further combinations.

FIG. 1 shows an isometric exploded illustration of a filter system for filtering a fluid, for example for filtering air, for example of a fuel cell system, according to an embodiment of the invention.

FIG. 2 shows a longitudinal section through the filter system according to FIG. 1.

FIG. 3 shows an isometric illustration of a round filter element according to an embodiment of the invention.

FIG. 4 shows a longitudinal section through the round filter element according to FIG. 3.

FIG. 5 shows an isometric illustration of the sorption element of the round filter element according to FIG. 3.

FIG. 6 shows a plan view of the round filter element according to FIG. 3.

FIG. 7 shows a detail of the longitudinal section through the round filter element according to FIG. 4.

FIG. 8 shows a longitudinal section through a round filter element according to a further embodiment of the invention.

FIG. 9 shows an isometric illustration of the sorption element of the round filter element according to FIG. 8.

FIG. 10 shows a plan view of the round filter element according to FIG. 8.

FIG. 11 shows a detail of the longitudinal section through the round filter element according to FIG. 8.

FIG. 12 shows a longitudinal section through a round filter element according to a further embodiment of the invention.

FIG. 13 shows an isometric illustration of the sorption element of the round filter element according to FIG. 12.

FIG. 14 shows a plan view of the round filter element according to FIG. 12.

FIG. 15 shows a longitudinal section through a round filter element according to a further embodiment of the invention.

FIG. 16 shows an isometric illustration of the sorption element of the round filter element according to FIG. 15.

FIG. 17 shows a plan view of the round filter element according to FIG. 15.

FIG. 18 shows a longitudinal section through a round filter element according to a further embodiment of the invention.

FIG. 19 shows an isometric illustration of the sorption element of the round filter element according to FIG. 18.

FIG. 20 shows a plan view of the round filter element according to FIG. 18.

FIG. 21 shows a detail of the plan view of the round filter element according to FIG. 20.

FIG. 22 shows a longitudinal section through a round filter element according to a further embodiment of the invention.

FIG. 23 shows an isometric illustration of the sorption element of the round filter element according to FIG. 22.

FIG. 24 shows a plan view of the round filter element according to FIG. 22.

FIG. 25 shows a detail of the longitudinal section through the round filter element according to FIG. 22.

FIG. 26 shows a longitudinal section through a round filter element according to a further embodiment of the invention.

FIG. 27 shows an isometric illustration of the sorption element of the round filter element according to FIG. 26.

FIG. 28 shows a plan view of the round filter element according to FIG. 26.

FIG. 29 shows a detail of the longitudinal section through the round filter element according to FIG. 26.

### DETAILED DESCRIPTION

In the drawing figures, same or same-type components are identified with same reference characters. The drawing figures show only examples and are not to be understood as limiting.

Directional terminology used in the following with terms such as “left”, “right”, “top”, “bottom”, “in front of”, “behind”, “subsequent to” and the like serve only for better understanding the drawing figures and are not to represent any limitation of the generality in any case. The illustrated components and elements, their embodiment and use may vary in the context of considerations of a person of skill in the art and be adapted to the respective applications.

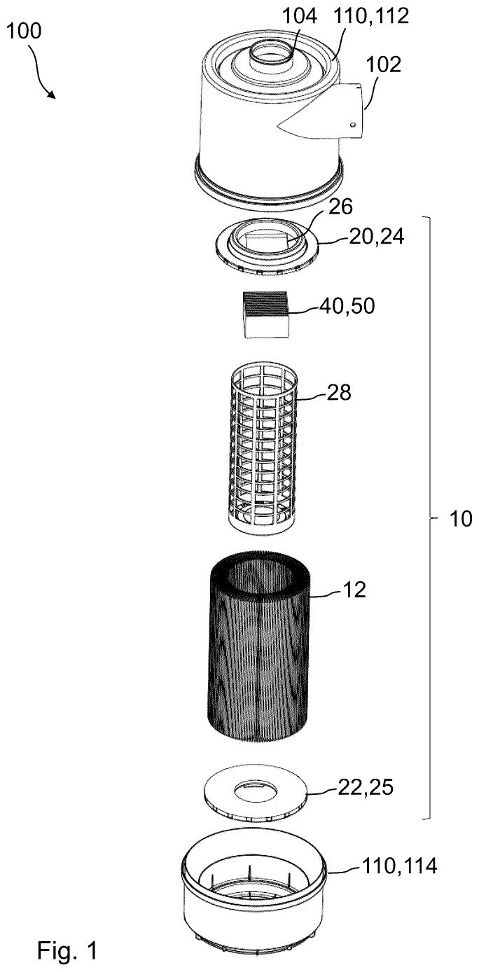

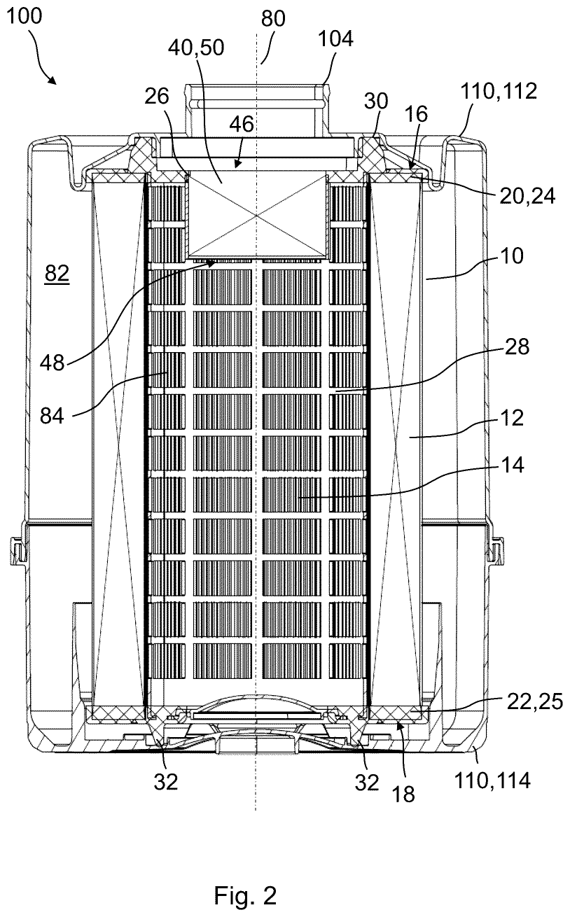

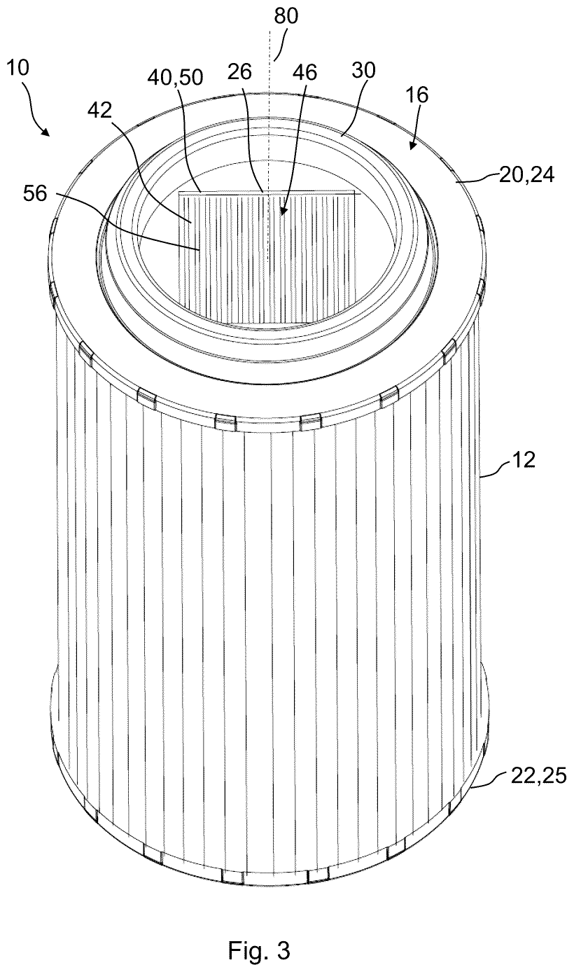

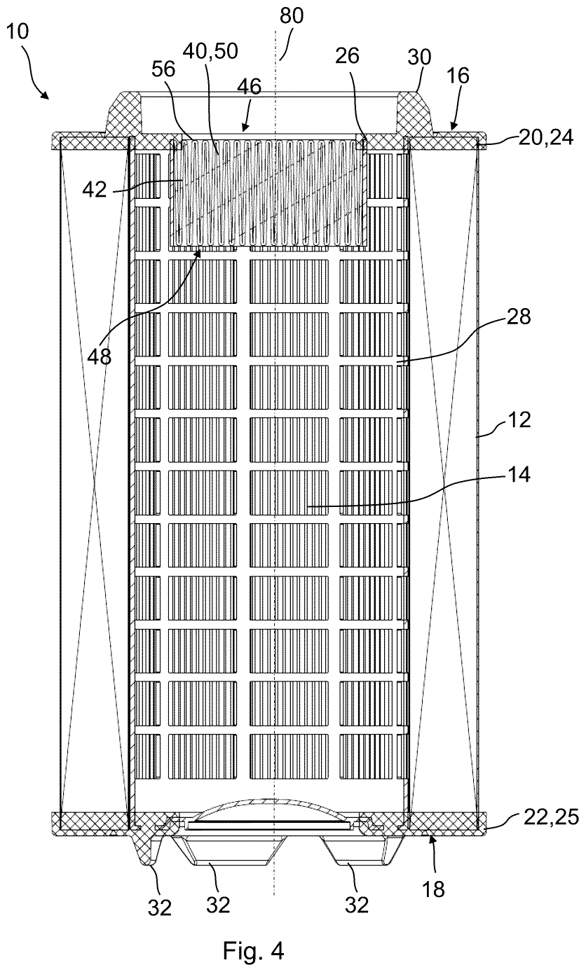

FIG. 1 shows an isometric exploded illustration of a filter system 100 for filtering a fluid, for example for filtering air, for example of a fuel cell system, according to an embodiment of the invention, while in FIG. 2 a longitudinal section through the filter system 100 is illustrated. FIG. 3 shows an isometric illustration of the round filter element 10 arranged in the filter system 100, while FIG. 4 shows a longitudinal section through the round filter element 10.

The filter system 100 comprises a filter housing 110 with a tangentially arranged fluid inlet 102 and an axially arranged fluid outlet 104. In the filter housing 110, which comprises a first housing part 112 and a second housing part 114, a round filter element 10 is arranged between the fluid inlet 102 and the fluid outlet 104 in the longitudinal axis 80.

The round filter element 10 comprises a filter medium body 12 with a particle filter medium surrounding the longitudinal axis 80 and enclosing an interior 14. The filter medium body 12 may be configured, for example, as a folded cellulose bellows or synthetic bellows.

The round filter element 10 comprises furthermore two end bodies 20, 22 which delimit the filter medium body 12 at the end faces 16, 18 facing away from each other. One of the end bodies 20 is configured as an open end plate 24 and comprises a through opening 26 which is in fluid communication with the interior 14. The filtered fluid may flow out through the through opening 26 of the end plate 24 to the fluid outlet 104. The filter medium body 12 may be supported at the interior 14 by a support element, for example by a cylindrical central tube 28 having a plurality of radial perforations.

The other end body 22 is also configured as an end plate 25.

The end plates 24, 25 may be, for example of plastic material, polyurethane (PUR) foam or sheet metal.

The end plate 24 comprises a circumferential seal 30 which is formed of the material of the end plate 24 and is oriented in direction of the longitudinal axis 80.

Since the round filter element 10 is flowed through by the fluid from the exterior to the interior in radial direction, a raw fluid region 82 located radially externally of the round filter element 10 may be sealed by means of this seal 30 in relation to the interior 14 of the round filter element 10 with the clean fluid region 84.

The second end plate 25 comprises axially projecting support elements 32. When installing the round filter element 10 in the filter housing 110, the round filter element 10 is clamped by means of the seal 30 and the support elements 32 against the filter housing 110 as soon as the first housing part 112 is connected to the second housing part 114, for example, screwed or clamped.

Further, the round filter element 10 comprises a sorption element 40 which is arranged in the through opening 26 of the open end plate 24 and fixedly connected directly or indirectly to the filter medium body 12 or the end plate 24. The sorption element 40 may be flowed through by the fluid serially in relation to the filter medium body 12 in direction of the longitudinal axis 80 in an operating state.

As seen in FIG. 4, the sorption element 40 projects at least partially into the interior 14 of the filter medium body 12 in direction of the longitudinal axis 80. The sorption element 40 is delimited in direction of the longitudinal axis 80 by oppositely positioned end faces 46, 48. In this context, one end face 46 of the sorption element 40 is flush with the open end plate 24.

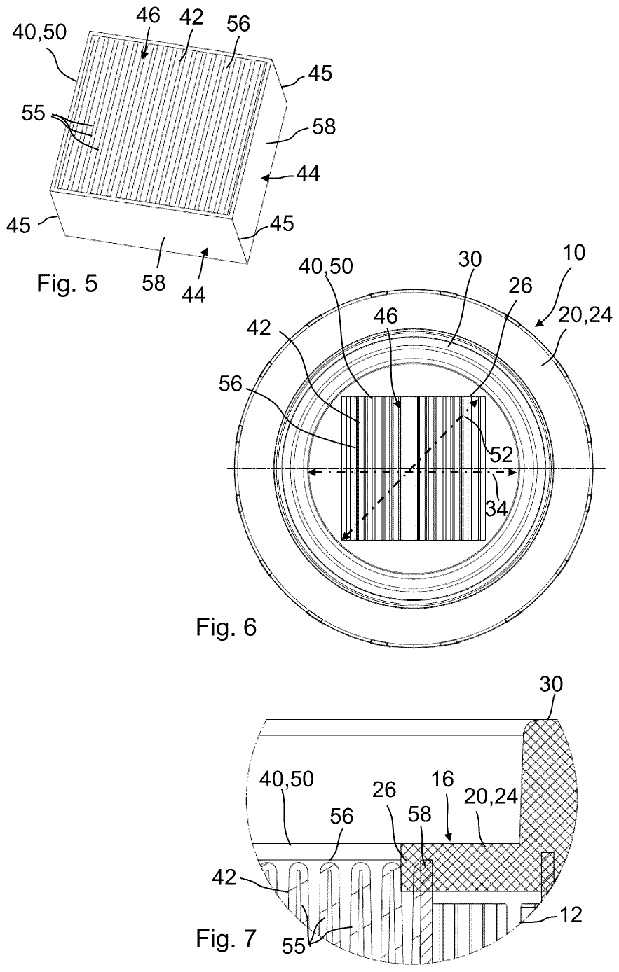

FIG. 5 shows an isometric illustration of the sorption element 40 of the round filter element 10. In FIG. 6, a plan view of the round filter element 10 is illustrated.

As seen in FIGS. 5 and 6, the sorption element 40 comprises a cuboid contour 50 which is aligned with outer edges 45 substantially in direction of the longitudinal axis 80. In this context, a diagonal 52 of an end face 46, 48 of the cuboid contour 50 corresponds at most to a diameter 34 of the through opening 26 of the end plate 24. This means that the sorption element 40, as illustrated, may be fitted with its outer contour into the through opening 26 of the end plate 24.

For adsorption of harmful gases, the sorption element 40, for example, may comprise active carbon, wherein the latter, enclosed between synthetic media layers, may be processed to an active carbon medium. This active carbon medium may be processed to a pleated bellows. In FIGS. 1 to 7, the sorption element 40 comprises such a folded sorption medium 42 whose fold edges 56 are arranged perpendicularly to the longitudinal axis 80.

The sorption element 40 comprises a lateral band 58 at the axially extending exterior sides 44. The folds 55 of the sorption medium 42 are thus seal-tightly closed by the lateral band 58.

FIG. 7 shows a detail of the longitudinal section through the round filter element 10 according to FIG. 4. In this context, it may be seen how the sorption element 40 is joined to the end plate 24. The folds 55 of the sorption element 40 are sealed at the axially extending exterior sides 44 of the cuboid contour 50 by the lateral band 58. The outermost fold 55 and the lateral band 58 are integrated into the material of the end plate 24, for example connected by material fusion to the end plate 24. For this purpose, the lateral band 58 may be embedded by molding in the end plate 24, for example.

In this manner, the sorption element 40 is effectively sealed in relation to the through opening 26 of the end plate 24.

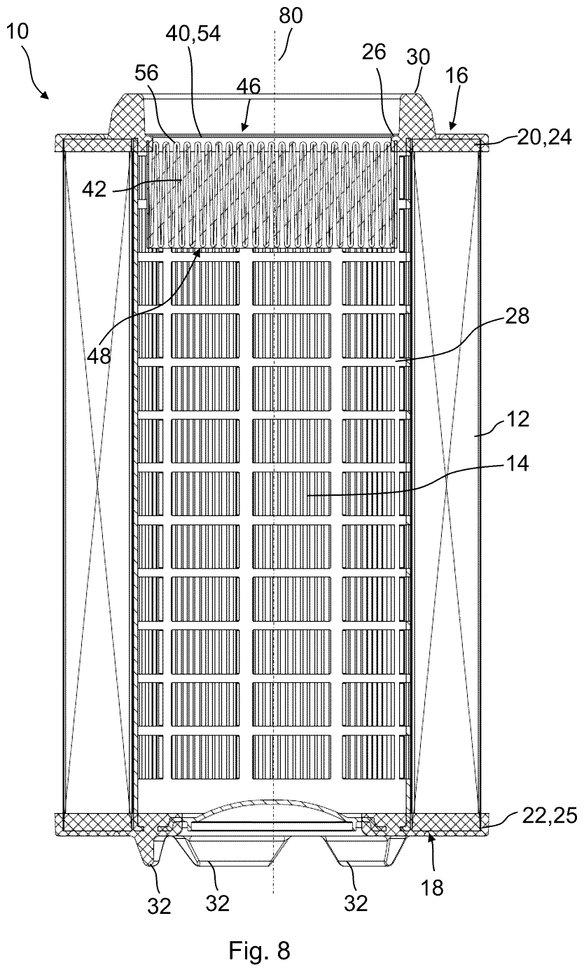

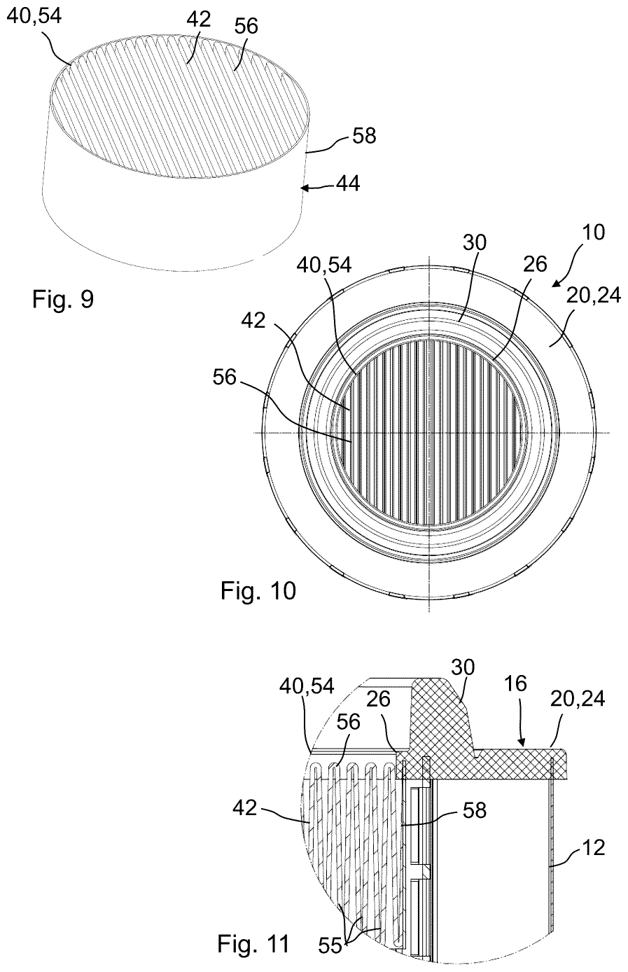

FIG. 8 shows a longitudinal section through a round filter element 10 according to a further embodiment of the invention. FIG. 9 shows in this context an isometric illustration of the sorption element 40 of the round filter element 10, while in FIG. 10 a plan view of the round filter element 10 and in FIG. 11 a detail of the longitudinal section through the round filter element 10 are illustrated.

The round filter element 10 illustrated in FIGS. 8 to 11 is constructed similarly to the embodiment illustrated in FIGS. 1 through 7. The sorption element 40 comprises also a folded sorption medium 42, however as a cylinder-shaped contour 54 which is aligned with a cylinder axis parallel, for example centered, to the longitudinal axis 80. In this context, the sorption element 40 which is arranged radially inside the through opening 26 of the end plate 24 fills the through opening 26 completely.

Such a cylinder-shaped contour 54 may be achieved in that a cuboid filter bellows is cut at the outer edges, for example, by means of a laser.

The sorption element 40 is also sealed by a lateral band 58 at the axially extending exterior side 44. In the section illustration in FIG. 11 it may be seen that the sorption element 40 is also embedded with the outermost folds 55 and the lateral band 58 in the end plate 24, for example is molded with the end plate 24.

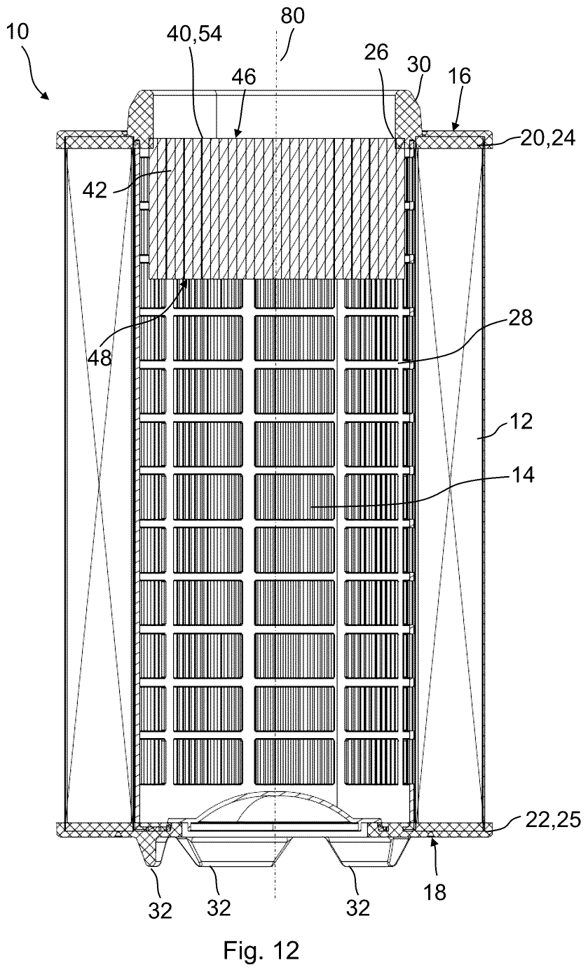

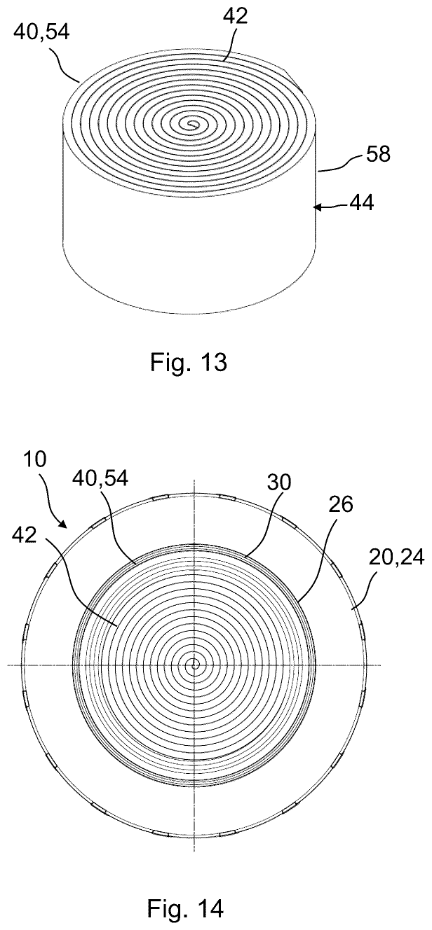

FIG. 12 shows a longitudinal section through a round filter element 10 according to a further embodiment of the invention. FIG. 13 shows in this context an isometric illustration of the sorption element 40 of the round filter element 10, while in FIG. 14 a plan view of the round filter element 10 is illustrated.

In this embodiment, the sorption element 40, comprising also a cylinder-shaped contour 54, comprises a sorption medium 42 which is wound around the longitudinal axis 80. The active carbon medium may thus be wound in a simple manner to a filter bellows. The exterior side 44 may be sealed optionally in addition by a lateral band 58, as illustrated in FIG. 13. Such a sorption element 40 may be manufactured in a cost-efficient manner and may completely fill the through opening 26 of the end plate 24 without having to be suitably cut to size.

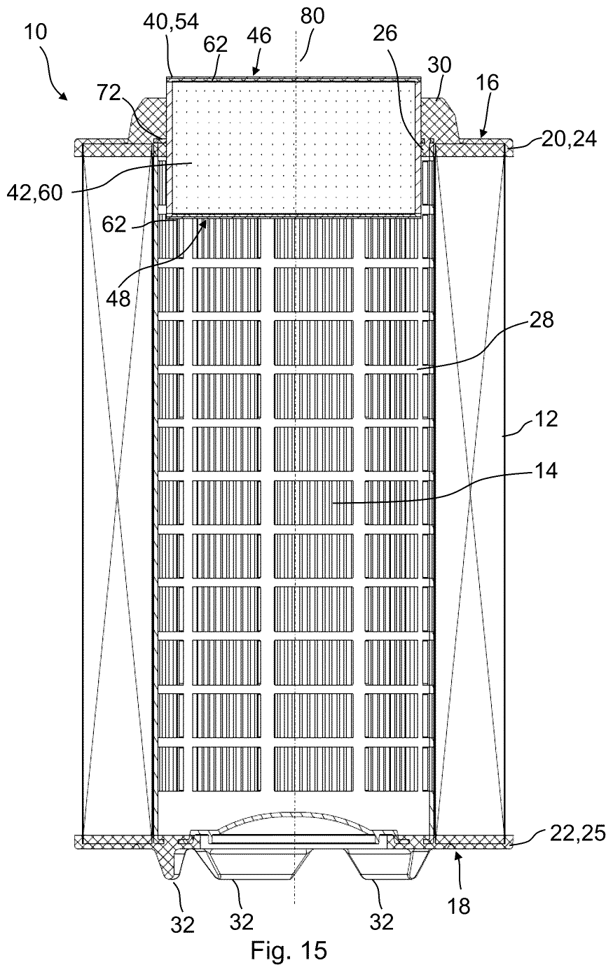

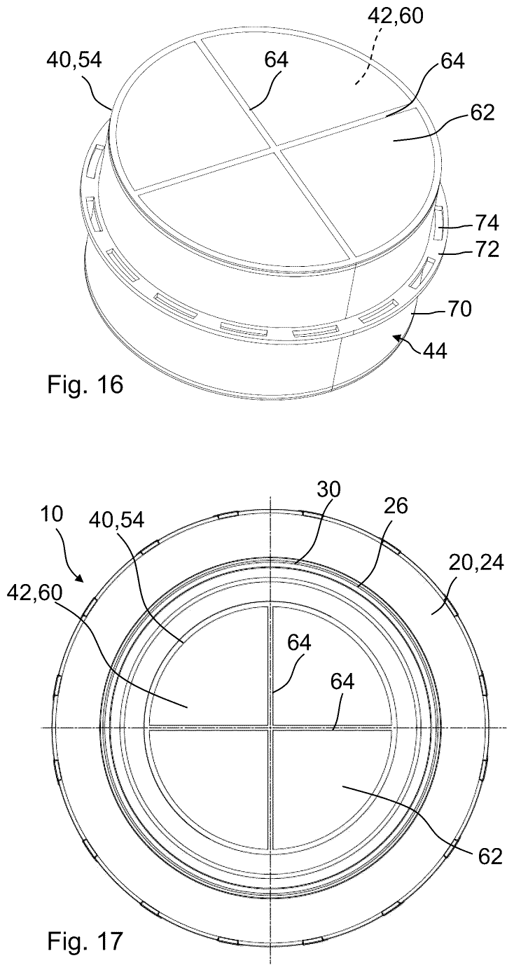

FIG. 15 shows a longitudinal section through a round filter element 10 according to a further embodiment of the invention. FIG. 16 shows in this regard an isometric illustration of the sorption element 40 of the round filter element 10, while in FIG. 17 a plan view of the round filter element 10 is illustrated.

As seen in FIG. 15, the sorption element 40 at least partially projects from the open end plate 24 of the filter medium body 12 past the end face 16 in direction of the longitudinal axis 80. The sorption element 40 is thus arranged partially in the interior 14 and partially in the exterior of the round filter element 10.

In addition, the sorption element 40 which is formed with a cylinder-shaped contour 54 comprises a sorption medium 42 which is configured as loose material 60. The loose material 60 may be arranged, for example, in a housing 70, for example, a plastic housing, wherein a permeable nonwoven 62 may be arranged at end faces 46, 48 of the sorption element 40, respectively. The nonwoven 62 holds the loose material 60 in the housing 70 but still enables the fluid to axially flow through the sorption element 40. At least one end face 46, 48, for example at least the end face 46 disposed downstream, may comprise reinforcement ribs 64 against the flow pressure of the flowing fluid. These reinforcement ribs 64 may be arranged, for example, in form of crossing ribs, across the end face 46.

At the exterior side 44, the housing 70 may comprise a circumferential frame 72, at least partially provided with perforations 74 which may be integrated into the end plate 24. For example, the perforations 74 in the frame 72 enable an interlocking with the end plate 24. Upon molding the end plate 24 with the frame 72, a fixed connection between sorption element 40 and end plate 24 may be produced in this way.

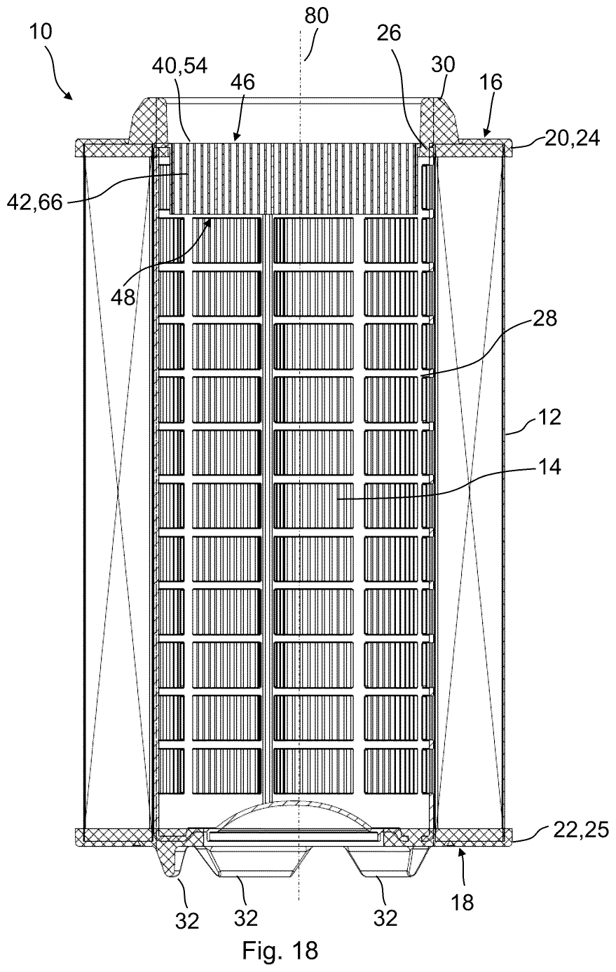

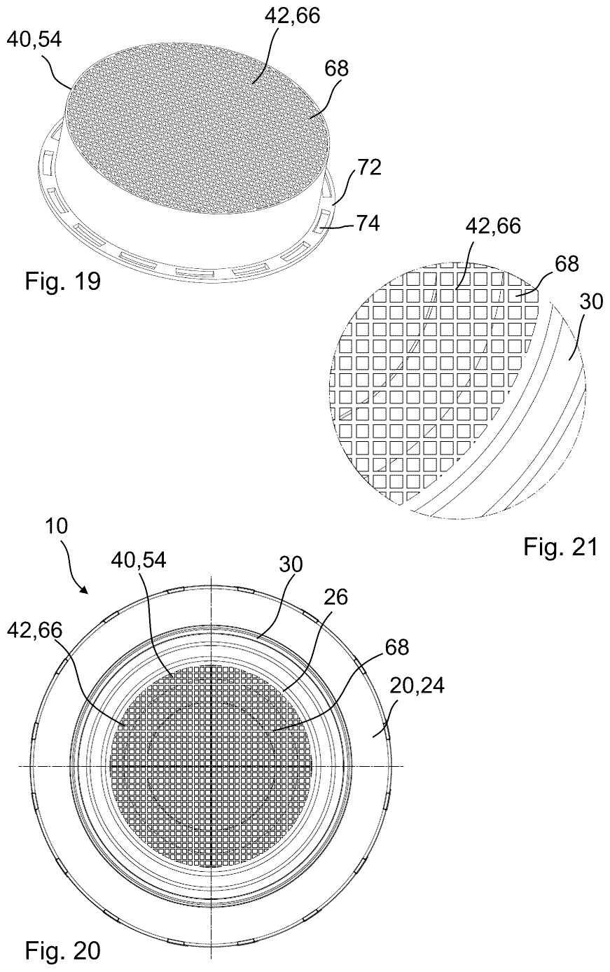

FIG. 18 shows a longitudinal section through a round filter element 10 according to a further embodiment of the invention. FIG. 19 shows an isometric illustration of the sorption element 40 of the round filter element 10, while in FIG. 20 a plan view of the round filter element 10 is illustrated. FIG. 21 shows a detail of the plan view according to FIG. 20.

As seen in FIG. 18, the sorption element 40 is flush with the end face 16 of the open end plate 24 of the filter medium body 12 in direction of the longitudinal axis 80. The sorption element 40 is thus arranged in the interior 14 of the round filter element 10.

As seen in FIG. 19 and for example in the detail view of FIG. 21, the sorption element 40 which is formed with a cylinder-shaped contour 54 comprises a honeycomb structure 66. The honeycomb structure 66 comprises channels 68 open in direction of the longitudinal axis 80 through which the fluid to be filtered may flow. In this context, the honeycomb structure 66 may comprise a sorption medium 42. For example, the honeycomb structure 66 may be coated with the sorption medium 42. The honeycomb structure 66 may be produced efficiently as an extruded plastic body, for example.

The sorption element 40 comprises furthermore, like the preceding embodiment, a frame 72 with perforations 74 surrounding the sorption element 40 which may be expediently embedded in, for example molded with, the end plate 24 of the round filter element 10.

As seen for example in the enlarged detail view of FIG. 21, the honeycomb structure 66 illustrated in the embodiment of FIGS. 18 to 21 comprises identical channels 68 with square cross section for flow of the fluid therethrough. As an alternative, it is however also possible that the channels have different, even irregularly formed, cross sections.

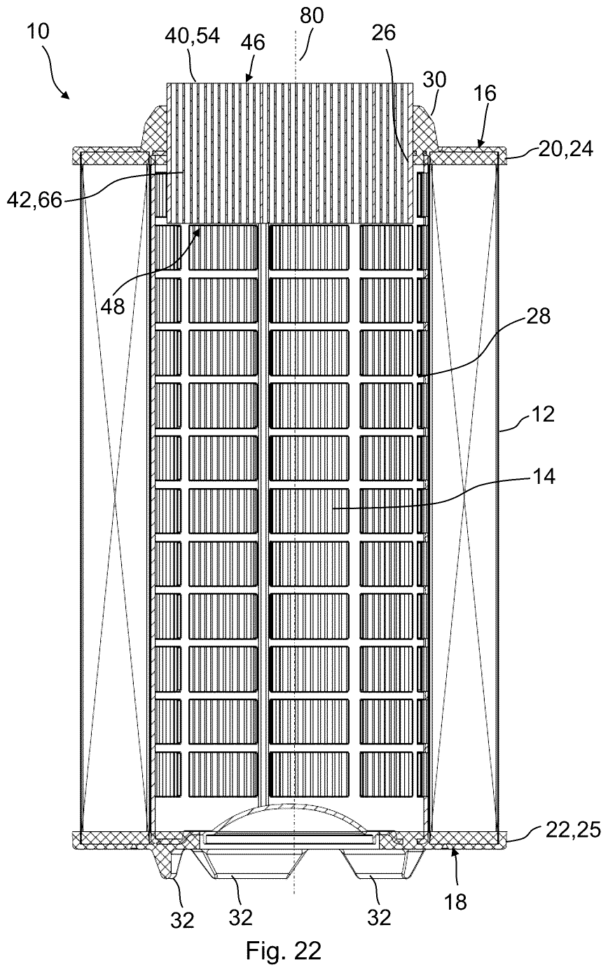

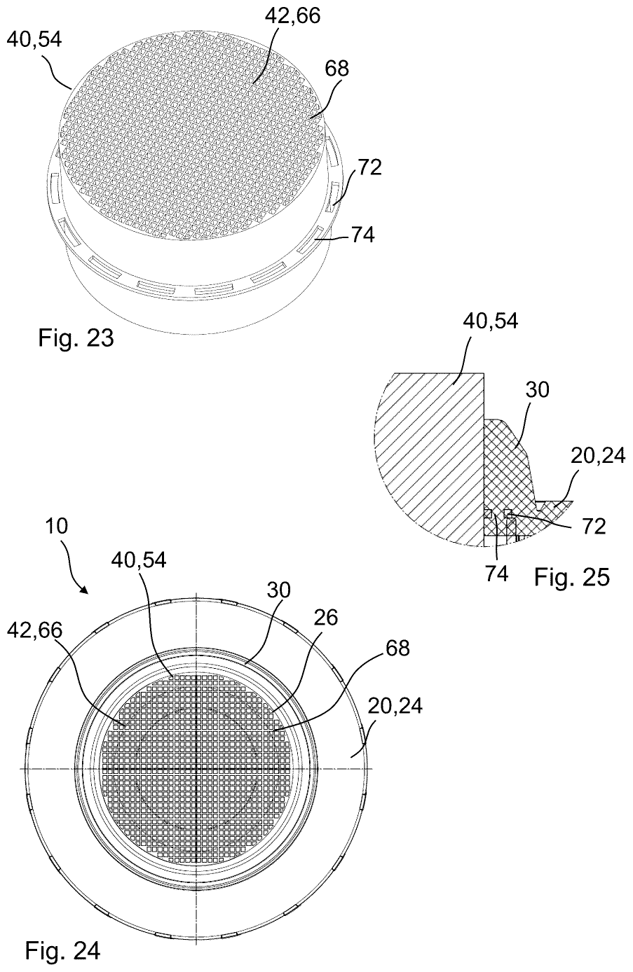

FIG. 22 shows a longitudinal section through a round filter element 10 according to a further embodiment of the invention. FIG. 23 shows an isometric illustration of the sorption element 40 of the round filter element 10, while in FIG. 24 a plan view of the round filter element 10 is illustrated. FIG. 25 shows a detail of the longitudinal section according to FIG. 22.

The embodiment illustrated in FIGS. 22 to 25 comprises a similar sorption body 40 in honeycomb structure 66 as the embodiment in FIGS. 18 to 21. The difference resides in that the sorption element 40 illustrated in FIGS. 22 to 25 at least partially projects from the open end plate 24 of the filter medium body 12 past the end face 16 in direction of the longitudinal axis 80. The sorption element 40 is thus arranged partially in the interior 14 and partially in the exterior of the round filter element 10.

The detail view in FIG. 25 shows in longitudinal section the connection of the sorption element 40 to the open end plate 24. For example, the seal 30 may be foamed onto the wall of the sorption element 40. In the longitudinal section of FIG. 25, embedding of the frame 72 of the sorption element 40 in the material of the end plate 24 may be seen. In this context, the perforations 74 of the frame 72 serve for a better interlocking with the material of the end plate 24.

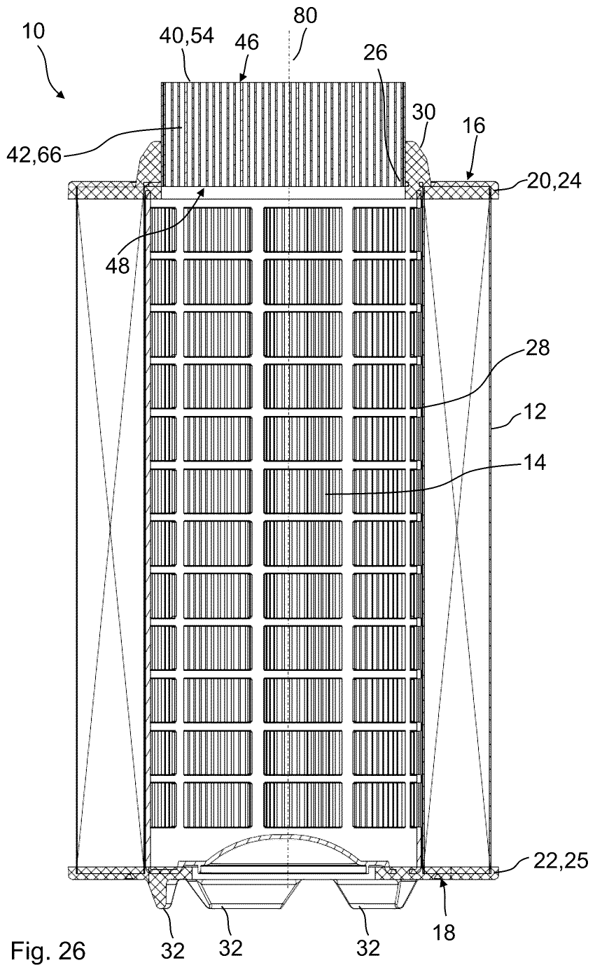

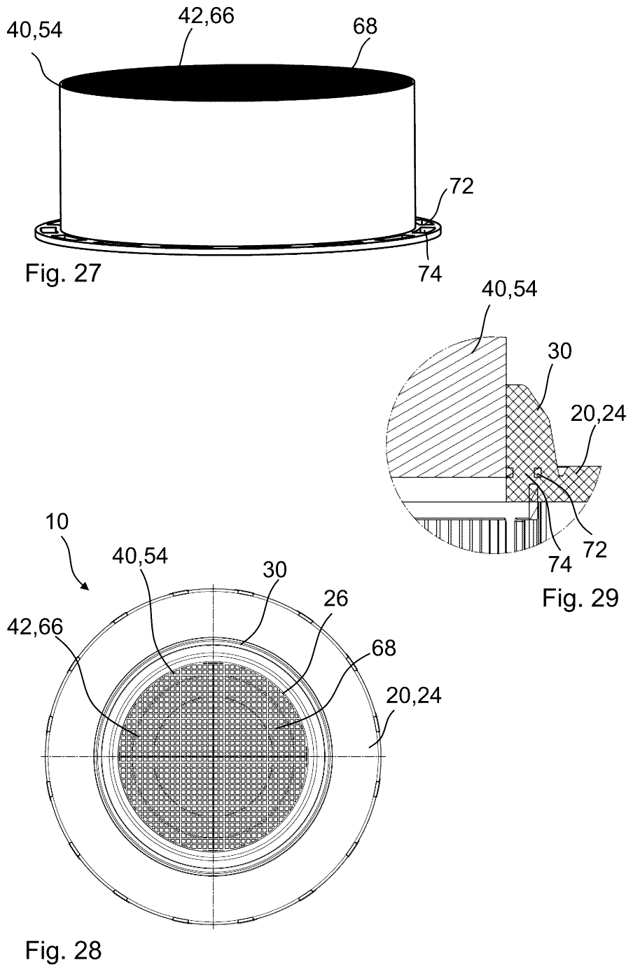

FIG. 26 shows a longitudinal section through a round filter element 10 according to a further embodiment of the invention. FIG. 27 shows an isometric illustration of the sorption element 40 of the round filter element 10, while in FIG. 28 a plan view of the round filter element 10 is illustrated. FIG. 29 shows a detail of the longitudinal section according to FIG. 26.

In this embodiment, the sorption element 40 is arranged completely in the exterior of the round filter element 10 and projects in direction of the longitudinal axis 80 past the end plate 24 into the fluid outlet 104 of the filter housing 110.

As in the two preceding embodiments, the sorption element 40 is configured again in honeycomb structure 66. In the longitudinal section of FIG. 29, embedding of the frame 72 of the sorption element 40 in the material of the end plate 24 may be seen. In this context, the perforations 74 of the frame 72 serve for better interlocking with the material of the end plate 24.

### REFERENCE CHARACTERS

10 filter element
12 filter medium body
14 interior
16 end face
18 end face
20 end body
22 end body
24 end plate
25 end plate
26 through opening
28 central tube
30 seal
32 support element
34 diameter
40 sorption element
42 sorption medium
44 exterior side
45 outer edges
46 end face
48 end face
50 cuboid contour
52 diagonal
54 cylinder-shaped contour
55 folds
56 fold edges
58 lateral band
60 loose material
62 nonwoven
64 reinforcement rib
66 honeycomb structure
68 channel
70 housing
72 frame
74 perforation
80 longitudinal axis
82 raw fluid region
84 clean fluid region
100 filter system
102 fluid inlet
104 fluid outlet
110 filter housing
112 first housing part
114 second housing part

That which is claimed is:

1. A round filter element for filtering a fluid, the round filter element comprising:
a filter medium body comprising a particle filter medium, wherein the filter medium body surrounds a longitudinal axis and encloses an interior of the filter medium body;
an end body delimiting the filter medium body at an end face, wherein the end body comprises an open end plate having a through opening in fluid communication with the interior;
a sorption element arranged in the through opening of the open end plate;
wherein the sorption element is configured to be flowed through by the fluid serially in relation to the filter medium body in a direction of the longitudinal axis; and
wherein the sorption element is sealed in relation to the through opening.

2. The round filter element according to claim 1, wherein the filter medium body is configured to be flowed through in a radial direction in relation to the longitudinal axis.

3. The round filter element according to claim 1, wherein the sorption element is embedded at least partially in the open end plate.

4. The round filter element according to claim 3, wherein the sorption element is connected by material fusion to the open end plate.

5. The round filter element according to claim 1, wherein the sorption element projects at least partially into the interior of the filter medium body in the direction of the longitudinal axis.

6. The round filter element according to claim 1, wherein the sorption element at least partially projects outwardly from the open end plate of the filter medium body past the end face in the direction of the longitudinal axis.

7. The round filter element according to claim 1, wherein the sorption element is delimited in the direction of the longitudinal axis by oppositely positioned end faces, wherein one of the end faces of the sorption element is flush with the open end plate of the filter medium body.

8. The round filter element according to claim 1, wherein the sorption element comprises a cuboid contour comprising outer edges aligned substantially in the direction of the longitudinal axis, and wherein a diagonal of an end face of the cuboid contour corresponds to at most a diameter of the through opening of the end plate.

9. The round filter element according to claim 1, wherein the sorption element comprises a cylinder-shaped contour comprising a cylinder axis, wherein the cylinder axis is aligned parallel in relation to the longitudinal axis, and wherein the sorption element is arranged radially inside of the through opening.

10. The round filter element according to claim 1, wherein the sorption element comprises a lateral band arranged at least at one axially extending exterior side of the sorption element.

11. The round filter element according to claim 10, wherein the sorption element is seal-tightly closed by the lateral band at the at least one axially extending exterior side of the sorption element.

12. The round filter element according to claim 10, wherein the lateral band at the at least one axially extending exterior side of the sorption element is embedded in the open end plate.

13. The round filter element according to claim 10, wherein the sorption element comprises a sorption medium wound around the longitudinal axis.

14. The round filter element according to claim 13, wherein the lateral band at the at least one axially extending exterior side of the sorption element is embedded in the open end plate.

15. The round filter element according to claim 1, wherein the sorption element comprises a sorption medium embodied as loose material.

16. The round filter element according to claim 1, further comprising a nonwoven arranged at an end face of the sorption element.

17. The round filter element according to claim 16, wherein the end face of the sorption element comprises at least one reinforcement rib.

18. The round filter element according to claim 1, wherein the sorption element comprises at least one reinforcement rib arranged at an end face of the sorption element.

19. The round filter element according to claim 1, wherein the sorption element comprises a honeycomb structure comprising channels open in the direction of the longitudinal axis, and wherein the sorption element comprises a sorption medium disposed on the honeycomb structure.

20. A filter system for filtering a fluid, the filter system comprising:
a filter housing with a fluid inlet and a fluid outlet; and
the round filter element according to claim 1, wherein the round filter element is arranged between the fluid inlet and the fluid outlet in the filter housing.
